(19) United States
(12) Patent Application Publication
(10) Pub. No.: US 2013/0191501 A1
(43) Pub. Date: Jul. 25, 2013

(54) Procedures for the Transfer of User Data

(71) Applicant: GE Energy Power Conversion GmbH, Berlin (DE)

(72) Inventors: Helmut Jebenstreit, Berlin (DE); Frank Wothe, Berlin (DE)

(73) Assignee: GE ENERGY POWER CONVERSION GMBH, Berlin (DE)

(21) Appl. No.: 13/715,691

(22) Filed: Dec. 14, 2012

(30) Foreign Application Priority Data
Dec. 16, 2011 (DE) 10 2011 088 812.8

(51) Int. Cl. H04L 29/08

(52) U.S. Cl. CPC H04L 67/02
USPC 709/217

(57) ABSTRACT

A method for transferring user data from a source application (20) of a source computing device (4) to a target application (22; 24) of at least one target computing device (6; 8) is described. The source computing device (4) and the target computing device (6; 8) are connected via Ethernet technology. In the method, the following chronologically sequential steps are carried out: Generation of an Ethernet telegram by the source computing device (4), in which case the telegram comprises the user data, and sending of the Ethernet telegram by the source computing device (4) to the target computing device (6; 8). When the Ethernet telegram is generated, always precisely the same, at least one, target computing device (6; 8) is specified through a MAC target address, for whose target application (22; 26) the user data are intended for. The source computing device (4) is always authorized for sending. The Ethernet telegram is sent without a connection to the target computing device (6; 8).

The invention refers to a method for transferring user data according to the generic term of claim 1.

It is known that computing devices can be interconnected to an Ethernet network for transferring data by means of Ethernet technology.

Furthermore, it is also known that network protocols based on Ethernet technology are applied in automation engineering as so-called field bus systems. Examples of them are Ethernet POWER LINK or EtherCAT (the latter is a registered trademark of Hans Beckhoff). These protocols require specialized hardware and/or need additional computing devices for arbitration, i.e. for time-slot allocation so user data can be sent.

A data transfer method is known from DE 10 2005 008 503 33, in which a connecting information is gathered via at least one transfer or forwarding destination in one data block. The block is transferred in form of a cell via one or several switching stations.

The task of the invention is to create a method for simplifying the transfer of user data and reducing the effort for setting up the corresponding network.

The task is solved by a method for transferring user data according to claim 1. Advantageous further developments are indicated in the sub-claims. Important invention characteristics are also found in the description and drawings given below, whereby the characteristics by themselves or in various combinations can be important for the invention without explicitly indicating this again.

Owing to the fact that the source computing device is always authorized to transmit, a multi-master operation of the method is possible, in which case every one of the source computing devices can send an Ethernet telegram or place it ready for sending at any time. Additional computing devices that specify time slots, for example, for sending Ethernet telegrams to the corresponding source computing device are therefore not needed and thereby transmission time can be reduced.

When an Ethernet telegram is generated via a target MAC address, at least one target computing device (for whose target application the user data are intended for) is always exactly pre-defined, additional transmission protocols—such as the Internet protocol (IP), for example—are not needed. No switching steps between different networks or via other protocols are needed, in which (depending on user data and target computing device) user data are partitioned into several telegrams, for example or whereby these several telegrams could take several paths through connected networks. The reduction of data to be sent achieved in this way results in a lower network load and therefore in a faster user data transmission. The avoidance of switching steps also contributes to faster user data transmission.

The connection-less sending of Ethernet telegrams further reduces the amount of data to be sent. The lower quantity of data and the connection set-up and termination that no longer take place contribute to the fact that an event recorded by the source computing device can be communicated as quickly as possible to the application of the target computing device.

Moreover, standard Ethernet components such as Ethernet building blocks and standard Ethernet cables, for example, can be used for making the use of especially adapted hardware and/or software unnecessary. Preferably, only the claimed process is used in an Ethernet network in order to avoid any other network traffic and therefore enhance the quality of user data transmission, especially with regard to transmission time.

When the Ethernet telegram is generated, several target computing devices are advantageously established via the target MAC address for receiving the Ethernet telegram. As a result of this, only one single user data transmission is necessary and the Ethernet network's load caused by Ethernet telegrams is reduced—which regarding the user data to be transmitted, leads to an overall faster communication. In this context, the use of a switch—especially a store-and-forward switch for temporarily storing the received Ethernet telegrams—allows every source computing device connected to the Ethernet network to send simultaneously because the switch can accept Ethernet telegrams in several connections at the same time.

In an advantageous further development of the method, a group of computing devices connected through Ethernet technology is addressed via the target MAC address. If the switch is used, it forwards all Ethernet telegrams to all other computing devices and this is the reason every computing device “sees” all Ethernet telegrams addressed in this way. Advantageously, a computing device not addressed via a group of computing devices discards an Ethernet telegram as soon as it receives it. As a result of this, a reduced load of the non-addressed computing device takes place in the area of the communication and/or application layer.

In an advantageous further development, a sender identification is established when the Ethernet telegram is generated in the Ethernet user data field of the Ethernet telegram. Regardless of the source MAC address of the respective Ethernet component, an implementation of the application layer and communication layer can occur, in which case preferably multicast addresses merely with regard to the target addresses must be taken into account with regard to the communication layer and possibly of the application layer too. The especially numerous multicast addresses are preferably defined for the Ethernet components of the respective computing devices.

In an advantageous embodiment of the method, a telegram number increased or decreased by a fixed value is specified for each telegram in which the target MAC address and sender identification match when the Ethernet telegram is generated in its Ethernet user data field. As a result of this, additional data safeguarding is created in the CRC verification that already exists in Ethernet technology. With this method, it can be verified whether one Ethernet telegram out of several has been lost.

In an advantageous further development of the method, an Ethernet telegram to be sent is placed ready for sending after a defined time span has elapsed. In this case, the time span starts the moment in which the Ethernet telegram previously sent was sent, whereby the target MAC address and the sender identification of the Ethernet telegram sent and to be sent match. As a result of this, a mechanism is created that advantageously contributes to the reduction of network load. This especially prevents a computing device from erroneously “flooding” the Ethernet network with Ethernet telegrams.

Further characteristics, possible applications and advantages of the invention result from the description of the invention's embodiments given below, which are shown in the drawings of the figures. In them, all characteristics described or shown are the object of the invention, either by themselves or in any combination, regardless of the way in which they were summarized in the patent claims or their back reference and regardless of their formulation or representation in the description or drawing. The same reference signs are also used for function-equivalent magnitudes in all figures, also in the case of different embodiments.

Exemplary embodiments of the invention are explained below with the help of drawings, which show:

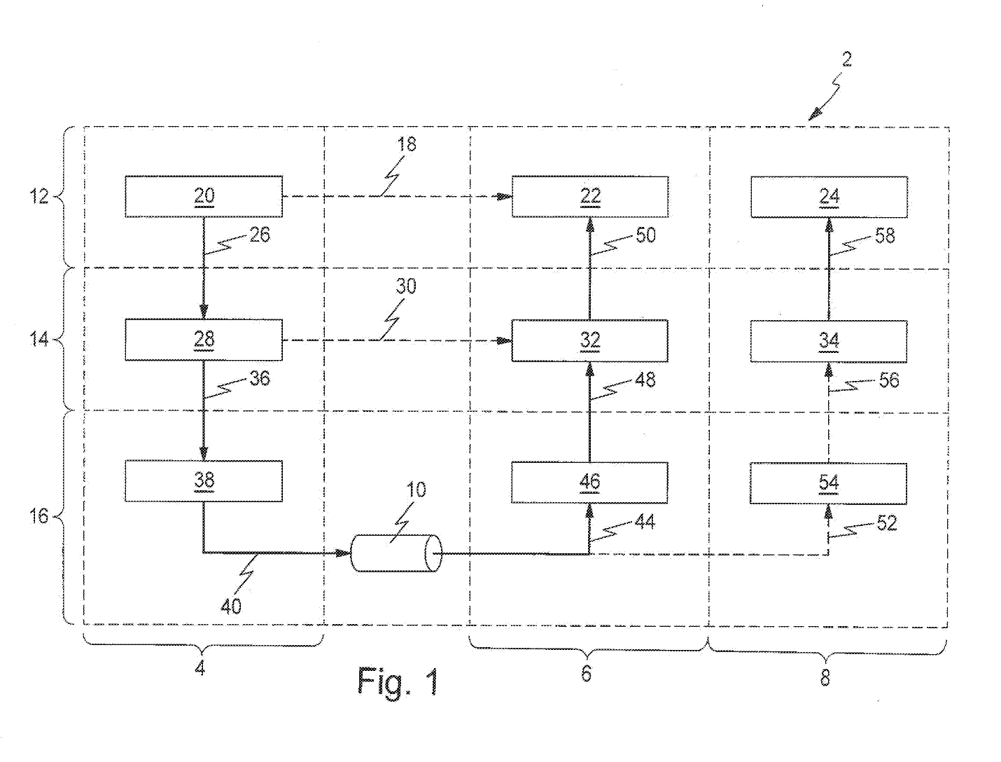

FIG. 1 a schematic representation of a protocol stack;

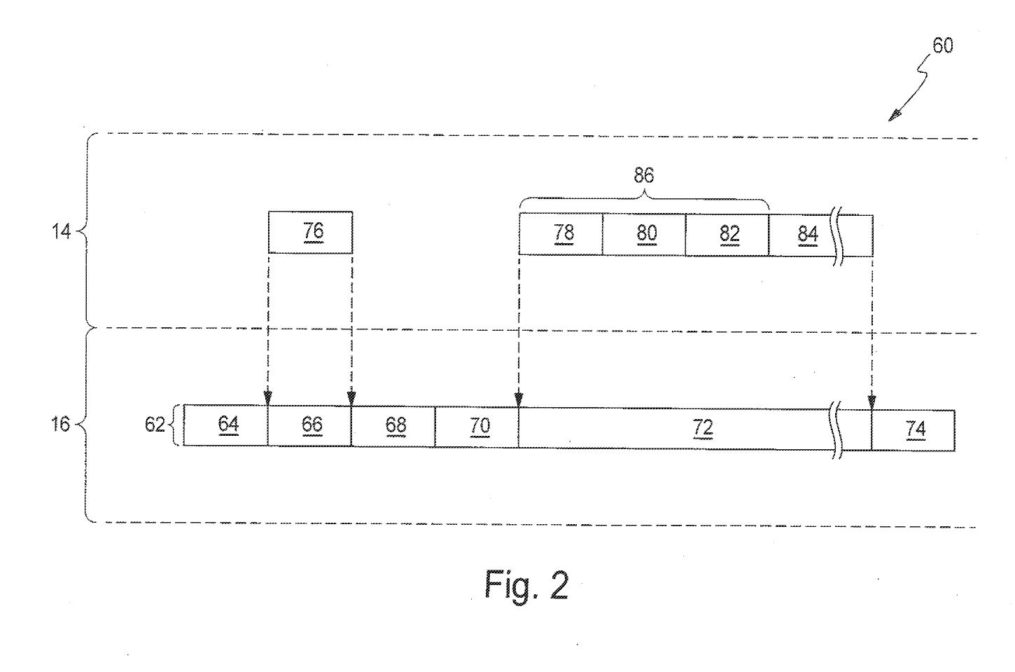

FIG. 2 a schematic representation of a telegram set-up;

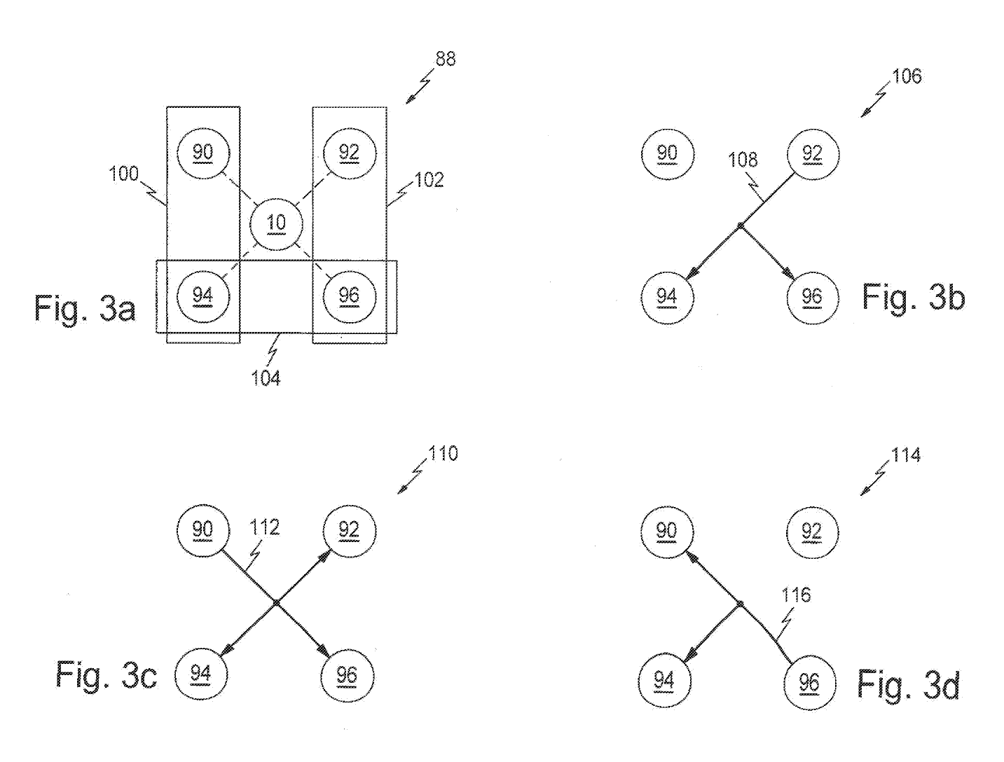

FIG. 3 a schematic representation of an addressing format;

FIGS. 3b-3d in each case, a schematic representation of a communication format; and

FIGS. 4 & 5 in each case, an exemplary execution of an Ethernet configuration.

FIG. 1 shows a schematic representation of a protocol stack 2 and also a source computing device 4, a target computing device 6 and an additional target computing device 8 in vertical direction. The source computing device 4 is physically linked to both target computing devices 6 and 8 via a schematically represented communication channel 10. The computing devices 4, 6 and 8 are processing computers of an automation system, for example. The computing devices 4, 6 and 8 constitute an Ethernet network. Naturally, only the two computing devices 4 and 6 can be linked to one another to create an Ethernet network.

The protocol stack 2 consists of the application layer 12, the secondary communication layer 14 and the secondary Ethernet layer 16, whereby each one of the layers 12, 14 and 16 are arranged horizontally.

According to an arrow 18, user data should be transmitted from a source application 20 of the source computing device 4 to a target application 22 of at least one target computing device 6. If apart from the target computing device 6, the target computing device 8 is addressed too, user data are transmitted both to target application 22 and to target application 24 of the target computing device 8, in which case user data transmission takes place via one single Ethernet telegram that will still be explained.

In accordance with arrow 26, user data are delivered to at least one communication unit 28, in which case additional protocol information can be specified directly or indirectly from the source application 20 (this will be explained below). According to arrow 30, user data should be transmitted together with the additional protocol information to a target communication unit 32 of the target computing device 6. With the respective addressing, user data should also be transmitted with additional protocol information to another target communication unit 34 of the target computing device 8.

In accordance with arrow 36, the source communication unit 28 transmits user data with the additional protocol information to an Ethernet component 38. The Ethernet component 38 generates an Ethernet telegram to be explained in more detail below in FIG. 2. The Ethernet telegram is therefore generated by the source computing device 4 and comprises the user data, which are likewise explained in more detail in FIG. 2. According to arrow 40, the Ethernet telegram is sent by the source computing device 4 and fed to communication channel 10.

In accordance with arrow 44, an Ethernet component 46 of the target computing device 6 receives the Ethernet telegram, which according to arrow 48 is made available to the target communication unit 32 or the Ethernet component 46 informs the target communication unit 32 that the Ethernet telegram has been received. According to arrow 50, the target communication unit 32 provides the user data of the target application 22.

With the respective addressing, the Ethernet telegram is also made available via an Ethernet component 54 according to arrow 52 and to the target communication unit 34 according to arrow 56. In accordance with arrow 58, the target computing device 8 provides the user data of the target application 24.

FIG. 1 shows user data transmission from a source application 20 of a source computing device 4 to a target application 22, 24 of at least one target computing device 6, 8. Originating from communication layer 14, the Ethernet telegram is generated in the Ethernet layer 16 of the source computing device 4. Thereafter, the Ethernet telegram is sent by the source computing device 4 through the Ethernet layer 16 by the target computing device 4. Afterwards, the Ethernet telegram is received by the target computing device 6 in the Ethernet layer 16. Subsequently, the target computing device 6, 8 of the target application 22, 24 provides the user data by means of the communication layer 14.

The source computing device 4 and the target computing device 6, 8 are connected to one another via Ethernet technology in accordance with Ethernet components 38, 46, 54 and the schematically represented communication channel 10. Therefore, the computing devices 4, 6, 8 jointly represent one Ethernet network. If the computing devices 4, 6, 8 are in each case part of a processing computer of an automation system, then the processing computers connected through Ethernet technology form an Ethernet network.

The source computing device 4 is always authorized to send, which means that the source computing device 4 determines the time for sending the telegram largely without the influence of other computing devices. The source application 20 generates the user data to be transmitted according to arrow 18 or makes the user data available to the source communication unit 28. User data are defined as data that do not exceed a certain size, in which case the size of the Ethernet program and its standard depend on the maximum quantity of data that can be received. In addition, however, the source computing device 4 can also specify a maximum size. If the user data to be sent exceed the specified size, then they are preferably fragmented by the source communication unit 28 and distributed to several Ethernet telegrams.

The source computing device 4 sends the Ethernet telegram to the target computing device 6, 8 without needing a connection. The connection-free sending of the Ethernet telegram means that no path for transmitting the Ethernet telegram is switched or established.

In accordance with arrow 26, the source application 20 triggers the measures leading to the sending of the Ethernet telegram according to arrow 40. Neither in application layer 12 nor in communication layer 14 have arbitration mechanisms been integrated to influence access to the communication channel 10. Any arbitration (i.e. channel access conflict resolution) is carried out by the Ethernet components 38, 46, 45 and/or the communication channel 10 itself. Therefore, the sending of the Ethernet telegram originating from the source computing device 4 depends only on the arbitration mechanisms mentioned above. Thus, the source computing device itself essentially determines the time when the Ethernet telegram is sent and is essentially independent from the other computing devices participating in the Ethernet network. The source computing device 4 thus sends the Ethernet telegram independently.

Ethernet components 38, 46 and 54 are readily available Ethernet components, connected with one another in the area of communication channel 10 with Ethernet components that are also readily available. Ethernet components 38, 46 and 54 are in each case assigned to computing devices 4, 6 and 8. In the area of communication layer 14 and of application layer 12, the respective applications or units are executed preferably as software. In the area of communication layer 14 and of application layer 12, however, it is naturally also possible to execute the units 28, 32 and 34 as hardware.

Two computing devices (for example, the source computing device 4 and the target computing device 6) or more than two computing devices make up an Ethernet network as long as they are connected to one another via the respective Ethernet components 38, 42, 46 and communication channel 10. Here, Ethernet technology comprises Ethernet components 38, 42, 46 and the Ethernet components in the area of communication channel 10, such as the corresponding cables and/or a switch, for example.

FIG. 2 shows a schematic representation of a telegram set-up 60 with the Ethernet telegram 62 generated by Ethernet component 38 according to FIG. 1 and sent via communication channel 10 according to arrow 40. The Ethernet telegram 62 is therefore assigned to the Ethernet layer 16. The Ethernet telegram 62 comprises essentially one preamble field 64, one target MAC address field 66 (MAC=media access control), one source MAC address field 68, one type field 70, one Ethernet user data field 72 and another field 74. This other field 74 contains, for example, a CRC field (CRC=cyclic redundancy check) intended for receiving a testing value in order to recognize errors during the transmission of the Ethernet telegram 62 on the side of the target computing device 6, 8. This CRC function is executed in Ethernet components 38, 46 and 54.

In communication layer 14, the source communication unit 28 of the source computing device 4 specifies one target MAC address 76, one sender identification 78, one telegram number 80, one date length 82 and the user data 84. The sender identification 78, the telegram number 80 and the data length 82 are generally known as additional protocol information 86. According to FIG. 1, the source computing device 4 generates the Ethernet telegram 62, in which case according to arrow 36 the target MAC address 76 is written in the target MAC address field 66 of the Ethernet telegram 62. The additional protocol information 86 is jointly written with the user data 84 in accordance with arrow 36 in the Ethernet user data field 72. The sending of the Ethernet telegram 62 by the source device 4 is initiated, for example, by the setting of a bit. This setting of the bit leads the Ethernet component 38 to send telegram 62 according to arrow 40.

When the Ethernet telegram 62 is generated, at least one of the target computing devices 6, 8 is specified by the source communication unit 28 via the target MAC address 76 and via the writing of this target MAC address 76, in the target MAC address field 66, of at least one of the target computing devices 6, 8, for which at least one target application 22, 24 is intended for the user data 84.

Depending on type of addressing (explained in more detail in FIGS. 3a-3d) via the target MAC address 76, the communication channel 10 and/or the Ethernet component 46 or 54 ensure that the additional protocol information 86 and the user data 84 are provided in accordance with arrow 48 or 56 of the communication unit 32 or 34.

Owing to the fact that when the Ethernet telegram 62 is generated in the Ethernet user data field 72 of the Ethernet telegram 62, a sender identification 78 is specified by the source communication unit 28, several sender identifications 78 can be assigned, on the one hand, to the source computing device 4 and, on the other hand, the protocol stack 2 shown in the application layer 12 and in the communication layer 14 of FIG. 1 is independent from a previously specified source MAC address in the Ethernet component 38. The sender identification 78 has preferably a size of 1 byte.

The source communication unit 28 specifies telegram number 80 when the Ethernet telegram 62 is generated in the Ethernet user data field 72 of the Ethernet telegram 62. Telegram number 80 is increased or decreased by one specified value (preferably by one) for every subsequent Ethernet telegram 62 in which the target MAC address 76 and the sender identification 78 match. Once the largest or smallest possible value is reached, the smallest or largest value for telegram number 80 is specified for the subsequent Ethernet telegram 62. The target communication unit 32 or 34 controls the telegram numbers 80 of the incoming additional protocol information 86 and the associated user data 84.

Data length 82 indicates the size that the subsequent user data 84 have in the Ethernet user data field 72. By means of the specified data length 82, the target communication unit 32, 34 can determine the area in which it will find the user data 84 in the Ethernet user data field 72 in order to specify or provide these user data 84 in accordance with arrow 50, 58 of target application 22, 24. For data length 82, 2 bytes are preferably provided.

FIG. 3a shows an addressing format 88 for computing devices 90, 92, 94 and 96, which are connected to one another via the schematically shown communication channel 10. This communication channel 10 is part of Ethernet technology. The computing devices 90, 92, 94 and 96 are executed both as source computing device and as target computing device.

All computing devices 90, 92, 94 and 96 can be selected as target computing device through a common broadcast address. By inserting the broadcast address as target MAC address 76 into the target MAC address field 66 of the Ethernet telegram 62, all computing devices 90 to 96 can thereby be addressed.

Furthermore, one or several of the computing devices 90 to 96 can be selected as target computing device through a multicast address, so that bi inserting a multicast address as target MAC address 76 in the target MAC address field 66 of the Ethernet telegram 62, a group 100, 102 or 104 of linked-up computing devices 90 to 96 can be addressed. Generally speaking, and with regard to the broadcast address and the multicast address, when generating the Ethernet telegram 62 via the target MAC address 76, several target computing devices 90 to 96 are specified for receiving the Ethernet telegram 62. Needless to say, however, only one of the computing devices 90 to 96 can also be addressed through the multicast address if no other computing device 90 to 96 has the same multicast address.

Basically, Ethernet technology generally specifies the broadcast address. With regard to the multicast address, and depending on the development of the Ethernet components 38, 46 and 54, several multicast addresses can be stored so that—as shown in the computing devices 94 and 96 of FIG. 3a—one computing device 94, 96 can have several multicast addresses. To do this, these multicast addresses are specified for the Ethernet components 38, 46 and 54, preferably by means of the respective communication unit 28, 32 and 34.

FIG. 3b shows a communication format 106, in which case the computing device 92 acts as source computing device and the Ethernet telegram 62 sends to group 104 according to arrow 108. To achieve this, the corresponding multicast address is written for the group 104 as target MAC address 76 in the target MAC address field 66 by the communication unit 16 of the computing device 92.

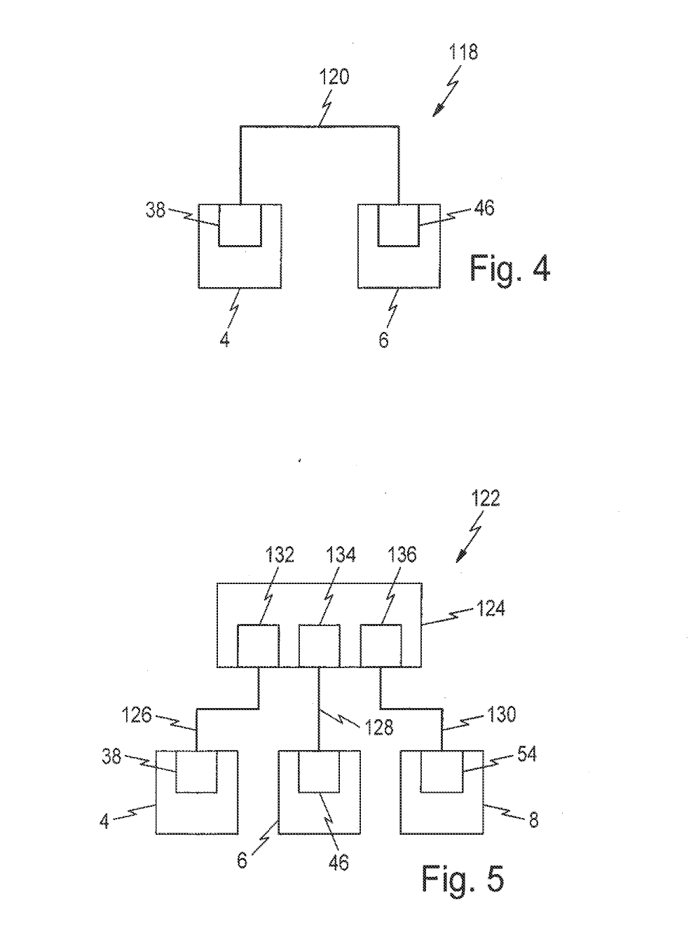

If the computing devices 90 to 96 are linked together via a switch, for example (explained in more detail in FIG. 5), then the switch does not recognize any difference between a broadcast address and a multicast address. For this reason, the switch basically distributes an Ethernet telegram 62 to all other connected computing devices with a multicast address or a broadcast address—in the case shown in FIG. 3b, to computing devices 90, 94 and 96. However, computing device 90 is not addressed via group 104, and for this reason the corresponding Ethernet component of Ethernet layer 16 of computing device 90 discards the Ethernet telegram 62 already upon receipt. Because of the fact that the Ethernet telegram 62 not intended for computing device 90 is already discarded in the Ethernet layer 16 of computing device 90 (particularly by the associated Ethernet component), the communication layer 14 and the application layer 12 of the computing device 90 are relieved because they no longer have to deal with the further processing of this discarded Ethernet telegram 62.

FIG. 3c shows a communication format 110, in which case the computing device 90 sends the Ethernet telegram 62 to the remaining computing devices 92, 94 and 96 according to arrow 112. In communication format 110, the computing device 90 addresses the corresponding Ethernet telegram 62 by means of the broadcast address in order to address all remaining computing devices 92 to 96 via the target MAC address 76.

FIG. 3d shows a communication format 114, in which case the computing device 96 transmits the Ethernet telegram 62 to the group 100 (i.e. to computing devices 90 and 94) according to arrow 116. Analogously, as already explained what happened to computing device 90 of FIG. 3b, the computing device 92 of FIG. 3d discards the Ethernet telegram 62 sent here already upon receipt.

The communication formats 106, 110 and 114 shown in FIGS. 3b to 3d run, for example, sequentially along communication channel 10. In this case, it is for example possible for computing devices 92, 90 and 96 to try to send the corresponding Ethernet telegrams 62 at the same time. This simultaneous sending creates a channel access conflict because only one common communication channel 10 is available. Here, Ethernet technology ensures the resolution of this conflict because various mechanisms intervene depending on the Ethernet technology employed. If, for example, the computing devices 90 to 96 are linked together via the switch (still to be explained below), then the computing devices 92, 90 and 96 can simultaneously send their telegrams 62 to the switch and the latter temporarily stores the Ethernet telegrams 62 and then distributes them to the network participants—in other words, to computing devices 90 to 96.

One computing device 90 to 96 can allocate itself own time slots for sending purposes in order to prevent this computing device 90 to 96, for example, from sending too many Ethernet telegrams 62 along communication channel 10. For example, one Ethernet telegram 62 can be placed ready for sending or be sent only after a predetermined time period has elapsed. In this case, the time period begins as soon as the previously sent Ethernet telegram 62 was sent and the target address 76 and the sender identification 78 of the Ethernet telegram 62 to be sent and sent match. Alternatively, however, the source computing device 4 itself can specify fixed times chronologically equidistant from one another, for example, for sending one of the Ethernet telegrams 62.

FIG. 4 shows an exemplary execution of an Ethernet configuration 118 where the source computing device 4 is linked to the target computing device 6 via a connection 120, for example an Ethernet cross cable. An Ethernet cross cable is characterized by interchanged cable wires for sending and receiving signals and allows two Ethernet components to be connected to one another that have the same assignment of the individual cable wires. The methods for transmitting user data from the source computing device 4 to the target computing device 6 explained above can be implemented via this Ethernet network.

FIG. 5 shows an exemplary execution of an Ethernet configuration 122 where the source computing device 4 is linked to the target computing devices 6 and 8 via the switch 124 mentioned above, In this case, the switch 124 can also be called Ethernet switch. Obviously, the computing devices 4, 6 and 8 shown in FIG. 5 (and in FIGS. 1 & 4) assume in each case the function of a source computing device and of a target computing device.

The Ethernet components 38, 46 and 54 of computing devices 4, 6 and 8 are in each case linked through a corresponding link 126, 128 and 130 to the respective connections 132, 134 and 136 of switch 124. Links 126, 128 and 130 are preferably Ethernet cables. In the arrangement shown in FIG. 5, the computing devices 4, 6 and 8 can send Ethernet telegrams 62 at any point in time via links 126, 128 and 130, in which case the switch 124 ensures a conflict resolution by temporarily storing the incoming Ethernet telegrams 62 and then sending them via the corresponding connections 132, 134 and 136 to computing devices 4, 6 and 8. For this reason, the switch 124 is also known as a store-and-forward switch.

The methods described above can be executed as computer program for at least one of the computing devices 4, 6, 8, 90, 92, 94 or 98. The computing device 4, 6, 8, 90, 92, 94 or 98 is suitable for executing the methods described above as a computer program. A processing computer of an automation system comprises the computing device 4, 6, 8, 90, 92, 94 or 98, especially a microprocessor. The processing computer and/or the computing device 4, 6, 8, 90, 92, 94 or 98 comprise a storage medium on which the computer program is saved. Processing computers of an automation system linked by Ethernet technology form an Ethernet network. Two processing computers can be linked together directly or via switch 124. More than two processing computers are linked together via switch 124.

1. Method for transmitting user data (84) from a source application (20) of a source computing device (4) to a target application (22; 24) of at least one target computing device (6; 8), in which case the source computing device (4) and the target computing device (6; 8) are linked together by means of Ethernet technology and whereby the method comprises the following chronologically sequential steps:
Generation of an Ethernet telegram (62) by the source computing device (4), whereby the telegram (62) comprises the user data (84), and
Sending of the Ethernet telegram (62) by the source computing device (4) to the target computing device (6; 8),
characterized in that,
when the Ethernet telegram (62) is generated through a target MAC address (76), always precisely the same, at least one target computing device (6; 8) is specified, for whose target application (22; 24) the user data are intended, that the source computing device (4) is always authorized for sending, and that the Ethernet telegram (62) is sent connection-free to the target computing device (6; 8).

2. Method according to claim 1, whereby all computing devices (90, 92, 94, 96) are addressed via Ethernet technology through the target MAC address (76).

3. Method according to claim 1, whereby a group (100; 102; 104) of computing devices (90, 92, 94, 96) linked up by Ethernet technology is addressed through the target MAC address (76).

4. Method according to claim 3, whereby a computing device (90; 92) not addressed via the group (104; 100) of computing devices discards the Ethernet telegram (62) already upon receipt.

5. Method according to claim 1, whereby upon the generation of the Ethernet telegram (62) in an Ethernet user data field (72) of the Ethernet telegram (62) a sender identification (78) allocated to the source application (20) and/or to the source computing device (4) is specified.

6. Method according to claim 5, whereby upon the generation of the Ethernet telegram (62) in an Ethernet user data field (72) of the Ethernet telegram (62) a telegram number (80) increased or decreased by a fixed value is specified for every subsequent Ethernet telegram (62) in which the target MAC address (76) and sender identification (78) match.

7. Method according to claim 5, whereby an Ethernet telegram (62) to be sent is placed ready for sending or is sent after a predetermined time span elapses, in which case the time span starts as soon as the previously sent Ethernet telegram (62) was placed ready for sending or was sent, and whereby the target MAC address (76) and the sender identification (78) of the Ethernet telegram (62) to be sent and the Ethernet telegram (62) sent match.

8. Computer program for a computing device (4; 6; 8; 90; 92; 94; 98) suitable for implementing the method according to claim 1.

9. Processing computer of an automation system equipped with a computing device (4; 6; 8; 90; 92, 94; 98), especially a microprocessor, on which a computer program can run according to claim 8.

10. Storage medium for a processing computer of an automation system according to claim 9 on which a computer program according to claim 8 has been saved.

11. Ethernet network with at least two processing computer linked by Ethernet technology according to claim 9.

12. Ethernet network according to claim 11, whereby the processing computers are linked to one another via an Ethernet switch (124).
